(19) United States
(12) Patent Application Publication
(10) Pub. No.: US 2012/0038161 A1
(43) Pub. Date: Feb. 16, 2012

(54) INLINE TURBINE GENERATOR

(75) Inventors: Luceille Outhred, Dry Creek (AU); Kevin Soper, Dry Creek (AU)

(73) Assignee: DIGISLIDE HOLDINGS LIMITED, Dry Creek (AU)

(21) Appl. No.: 13/142,059

(22) PCT Filed: Dec. 22, 2009
(86) PCT No.: PCT/AU2009/001676

§ 371 Date: Sep. 13, 2011

(30) Foreign Application Priority Data
Dec. 24, 2008 (AU) 2008906618

(51) Int. Cl. H02K 7/18

(52) U.S. Cl. 290/50; 290/52

(57) ABSTRACT

A power generating apparatus for fluid flow conduits where the apparatus includes an impeller positioned in the path of the fluid flow. The impeller is either directly or magnetically coupled to an electric generator outside of the fluid flow conduit. As the fluid flows it causes the impeller to rotate thus causing the electrical generator to turn and thereby produce electricity. This can then be used to power various devices or to trickle charge batteries. The fluid flow conduits may be common commercial or domestic water pipes or other systems such as solar water heaters and distillation devices.

### CROSS REFERENCE TO RELATED APPLICATION

This United States national stage application claims the benefit of priority of International Patent Application PCT/AU2009/001676, filed on Dec. 22, 2009, the entire disclosure of which is incorporated herein by reference.

### FIELD OF THE INVENTION

The present invention relates to an inline turbine generator for the generation of electricity and, in particular, to the use of an inline turbine generator including an impeller positioned in a fluid flow path.

### BACKGROUND OF THE INVENTION

Domestic and commercial water systems are typically provided with significant pressures. This reasonably high pressure delivery is required in order that sufficient water pressure is maintained at times when it is required. However, most domestic and commercial water users do not require the delivery of water at such high pressures.

In addition, there is presently great concern for the conservation of energy and one means of reducing domestic and commercial energy consumption would be to find an economical and efficient way to utilize the excess pressure of water supplied to water systems.

It is an object of the present invention to provide an inline turbine generator for fluid flow conduits, such as domestic and commercial water pipes, to generate electrical power.

It is a further object of the present invention to provide an inline turbine generator for fluid flow conduits, such as liquids flowing through solar panel pipes.

### SUMMARY OF THE INVENTION

Therefore, in one form of the invention there is proposed a power generating apparatus for fluid flow conduits, said apparatus including an impeller positioned in the path of said fluid flow, said impeller being coupled to an electric generator outside of said fluid flow conduit, whereby rotation of said impeller causes said electrical generator to turn and thereby produce electricity.

Preferably, said apparatus further includes a battery means for storing generated electrical energy.

In preference, said apparatus further includes a baffle attached along an internal wall of said fluid conduit for directing fluid onto the impeller, thereby ensuring that the impeller rotates at maximum velocity.

In preference, said apparatus further includes a means of streamlining fluid downstream of the impeller to minimize turbulence.

Preferably, said fluid is a liquid, including water. Preferably said fluid conduit is a domestic or commercial water line,

Alternatively, said fluid is a gas, including air. In preference said fluid conduit is an air line of an air compressor.

In preference, said impeller is coupled to the electric generator using a magnetic coupling which enables said generator to be removed, while the impeller remains in the path of flow in the fluid conduit.

Preferably, said apparatus further includes a sensor for detecting information relating to said fluid including the fluid flow rate.

Alternatively, said apparatus includes a computing means for calculating said information based on the, rate of rotation of the impeller.

In preference, said apparatus further includes visual indicia for indicating said information to a user.

In preference, said information includes fluid consumption. Preferably said information includes the electrical energy generated.

In a further form of the invention there is proposed a power generating apparatus for fluid flow conduits, said apparatus including an inline turbine positioned in the fluid flow path, a generator associated with said inline turbine for converting rotational energy from the turbine into electrical energy, and a battery bank associated with said generator for storing said electrical energy.

Preferably, said electrical energy is used to power low voltage, appliances such as low voltage lighting.

In a still further form of the invention there is proposed a power saving system for domestic and commercial premises, said system including a plurality if inline turbines positioned in the fluid flow paths of fluid flow conduits in said premises, at least one generator associated with said inline turbines for converting rotational energy from the turbine into electrical energy, and an electrical appliance docking station associated with said generator for storing said electrical energy and supplying power to appliances docked in said station.

Preferably, said docking station accommodates and energizes low voltage electrical appliances, including remote control devices.

### BRIEF DESCRIPTION OF THE DRAWINGS

The accompanying drawing, which is incorporated in and constitutes a part of this specification, illustrates an implementation of the invention and, together with the description, serves to explain the advantages and principles of the invention.

FIG. 1 illustrates schematically a fluid flow conduit including an inline turbine generator in accordance with the present invention.

### DESCRIPTION OF THE PREFERRED EMBODIMENTS

The following detailed description of the invention refers to the accompanying drawing. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts. It is to be understood that reference to the word “fluid” is not intended to be limited to liquids only. For example, “fluid” also includes within its scope gaseous substances such as air.

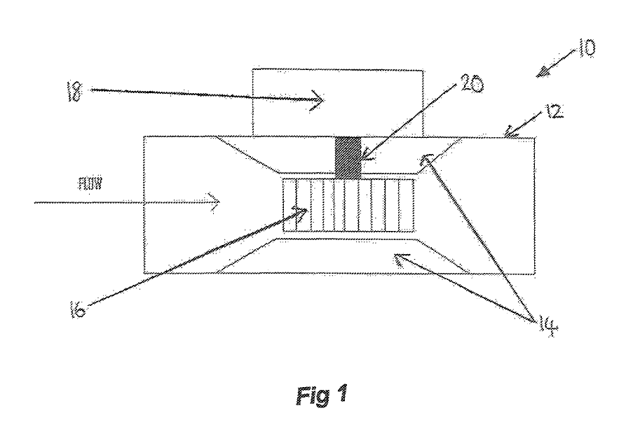

Turning now to FIG. 1, there is shown an apparatus 10 according to a first embodiment of the present invention. The apparatus 10 includes a fluid conduit 12 through which fluid travels, baffles 14 mounted along the inside wall of the conduits, an impeller 16 located between the baffles, and a generator 18.

In brief, when water flows through the conduit 12, it causes the impeller 16 to rotate. The impeller shaft 20 is coupled to the generator 18 such that the impeller turns the generator 18 either directly, or through a gearing mechanism (not shown), to generate power. The generated power can be used immediately, or stored in an associated battery bank (not shown). The generated power can then be used to power any low voltage electric appliance, including for example, low voltage lighting.

The baffles 14 are designed to direct fluid onto the impeller 16 at an angle that ensures the impeller rotates at maximum velocity. The angle of the baffles 14 is preferably adjustable so as to account for water flow and pressure, and to therefore maintain a constant flow across the vanes of the impeller 16. Adjustment of the baffles 14 could be manual, or by way of electric operation, in which case power generated from the system could also be used to power their adjustment.

It may also be necessary to include a mesh filter (not shown) upstream of the impeller 16 to stop debris building up in the impeller vanes. Additional baffles or other known devices (not shown) may also be installed downstream of the impeller 16 to ensure that the resulting flow is not turbulent.

It is to be understood that the size of the impeller 16 can be made to suit the pipe diameter. In preference, the coupling between the generator and the impeller is a magnetic coupling alleviating the need for a shaft seal. This allows the generator 18 to be changed or repaired without disrupting the fluid flow.

In accordance with a further embodiment, the impeller 16 could be fitted to a compressor or the like (not shown) having a fluid conduit 12 in the form of a compressed air line. In such circumstances, power would be generated each time the compressor is used. The present invention is not intended to be limited to only one use for the generated power. For example, the apparatus 10 could be installed into the water line of a shower, whereby electrical power that is generated from the flow of water through to the shower rose, could power a radio for a person to listen to while showering. The generated power could be used, for example, in the case of water pipes which extend across large expanses of land, to power a water heater or cooler. This would ensure that that the water in the pipes does not freeze in low temperature environments, or evaporate in high temperature environments.

The apparatus 10 may also include a sensor (not shown), or other suitable device in the fluid flow path, used to measure the fluid flow rate. Alternatively, an associated computing means could be used to calculate the fluid flow rate as a function of the rate of rotation of the impeller. It is envisaged that visual indicia shall also be incorporated into the apparatus 10 for indicating information to the user, including the fluid flow rate at that particular point in the pipe, the amount of electrical energy being generated through use of the apparatus 10, and generally any other information which may be calculated and deemed useful.

In these times of drought and water restrictions, it may be useful for a person to be informed instantaneously how much water they are consuming at any one time, for example, in the shower, or when watering the garden. The electrical energy generated by the apparatus 10 could be used to power such computational means and visual indicia.

A still further use of the generated power could be to provide the water line with a slight electrical charge so as to prevent electrolysis and hence rust in the pipe line from occurring.

It is to be further understood that the apparatus of the present invention can easily be retrofitted to existing fluid conduits. Alternatively, new fluid conduits may be constructed having multiple points there along that are configured to accommodate a plurality of the power generating apparatus.

It is envisaged that the apparatus 10 embodied herein will form part of a complete energy saving system for domestic use, whereby a docking station for electrical equipment such as remote control devices and other low voltage electrical appliances are to be docked, and thereby energized each time water is consumed.

It is also to be understood that the apparatus of the present invention can be placed in other fluid conduits means, such as solar panels where by virtue of the heat generated within fluid flow occurs that can drive the above apparatus.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

1. A power generating apparatus for a fluid flow conduit, said apparatus including an impeller positioned in the path of a fluid that flows through said fluid flow conduit, said impeller being coupled to an electrical generator outside of said fluid flow conduit, whereby rotation of said impeller causes said electrical generator to turn and thereby produce electrical energy.

2. A power generating apparatus as in claim 1, further including a battery means for storing the electrical energy generated by said electrical generator.

3. A power generating apparatus as in claim 1, further including a baffle attached along an internal wall of said fluid flow conduit for directing the fluid onto said impeller, thereby ensuring that said impeller rotates at maximum velocity.

4. A power generating apparatus as in claim 1, further including a means of streamlining the fluid downstream of said impeller to minimize turbulence.

5. A power generating apparatus as in claim 1, wherein the fluid is a liquid, including water.

6. A power generating apparatus as in claim 1, wherein said fluid flow conduit is a domestic or a commercial water line.

7. A power generating apparatus as in claim 1, wherein the fluid is a gas, including air.

8. A power generating apparatus as in claim 7, wherein said fluid flow conduit is an air line of an air compressor.

9. A power generating apparatus as in claim 1, wherein said impeller is coupled to said electrical generator using a magnetic coupling which enables said electrical generator to be removed while said impeller remains in the path of the fluid that flows through said fluid flow conduit.

10. A power generating apparatus as in claim 1, wherein the apparatus further includes a sensor for detecting information relating to the fluid, including the fluid flow rate.

11. A power generating apparatus as in claim 1, wherein the apparatus includes a computing means for calculating information based on the rate of rotation of the said impeller.

12. A power generating apparatus as in claim 10, wherein the apparatus further includes visual indicia for indicating the information to a user.

13. A power generating apparatus as in claim 12, wherein the information further includes fluid consumption.

14. A power generating apparatus as in claim 12, wherein the information further includes the electrical energy generated by said electrical generator.

15. A power generating apparatus for a fluid flow conduit, said apparatus including:
an inline turbine positioned in the path of a fluid that flows through said fluid flow conduit;
a generator associated with said inline turbine for converting rotational energy from said inline turbine into electrical energy; and
a battery bank associated with said generator for storing said electrical energy.

16. A power generating apparatus as in claim 15, wherein the electrical energy is used to power low voltage appliances, including low voltage lighting.

17. A power saving system for domestic and commercial premises, said system including:
a plurality if inline turbines positioned in a fluid that flows through one or more fluid flow conduits in said premises;
at least one generator associated with said plurality of inline turbines for converting rotational energy from said plurality of inline turbines into electrical energy; and
an electrical appliance docking station associated with said generator for storing said electrical energy and supplying power to an electrical appliance docked in said docking station.

18. A power saving system as in claim 17, wherein said docking station accommodates and energizes low voltage electrical appliances, including remote control devices.
